(19) United States
(12) Patent Application Publication
(10) Pub. No.: US 2015/0379287 A1
(43) Pub. Date: Dec. 31, 2015

(54) CONTAINERIZED APPLICATIONS WITH SECURITY LAYERS

(71) Applicant: defend7, Inc., Mountain View, CA (US)

(72) Inventors: Gaurav Mathur, Palo Alto, CA (US); Vibhav Sreekanti, Pleasanton, CA (US)

(21) Appl. No.: 14/520,544

(22) Filed: Oct. 22, 2014

Related U.S. Application Data
(60) Provisional application No. 62/016,703, filed on Jun. 25, 2014.

(51) Int. Cl. G06F 21/62

(52) U.S. Cl. CPC G06F 21/629

(57) ABSTRACT

Systems, methods, and software described herein provision secure application containers. In one example, a method of operating a provisioning system to provision secure application containers includes identifying an application to provision. The method further includes, in response to identifying the application, provisioning a secure application container for the application, the secure application container comprising a security layer for the application and the application.

### RELATED APPLICATIONS

This application is related to and claims priority to U.S. Provisional Patent Application No. 62/016,703, entitled “CONTAINERIZED SECURITY AS A SERVICE,” filed on Jun. 25, 2014, and which is hereby incorporated by reference in its entirety.

### TECHNICAL FIELD

Aspects of the disclosure are related to computing security and in particular to providing a secure container for applications.

### TECHNICAL BACKGROUND

An increasing number of data security threats exist in the modern computerized society. These threats may include viruses or other malware that attacks the local computer of the end user, or sophisticated cyber attacks to gather data and other information from the cloud or server based infrastructure. This server based infrastructure includes real and virtual computing devices that are used to provide a variety of services to user computing systems, such as data storage, cloud processing, web sites and services, amongst other possible services. To protect applications and services, various antivirus, encryption, and firewall implementations may be used across an array of operating systems, such as Linux and Microsoft Windows.

A firewall is a software or hardware-based network security system that controls the incoming and outgoing network traffic based on applied rule set. For example, a firewall may be implemented in a computing system to prevent incoming connections from possibly harmful computing systems. Further, encryption is the process of encoding messages or information in such a way that only authorized parties may read or understand the saved material. Thus, if users attempt to store sensitive information, such as social security information, encryption may be used as a failsafe to prevent unwanted parties from reading the information even if the stored data becomes accessible.

In addition to the protective measures discussed above, segregation methods have also been pursued to limit the interaction between systems and applications. These segregation methods include whole system virtualization, which includes a full operating system and one or more applications, as well as application containers that are used to reduce dependencies on other cooperating applications. However, separating the applications into different virtual machines or application containers can add complexity to the security configurations and deployment for each of the executing applications.

### OVERVIEW

Provided herein are systems, methods, and software to provision application containers with security layers. In one example, a method of operating a provisioning system to provision secure application containers includes identifying an application to provision. The method further includes, in response to identifying the application, provisioning a secure application container for the application, the secure application container comprising a security layer for the application and the application.

In another instance, a computer apparatus to provision secure application containers includes processing instructions that direct a provisioning computing system to identify an application to provision. The processing instructions further direct the provisioning computing system to, in response to identifying the application, provision the secure application container for the application, wherein the secure application container comprises a security layer for the application and the application. The computer apparatus further includes one or more non-transitory computer readable media that store the processing instructions.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates a computing environment to provision applications into secure application containers.

FIG. 2 illustrates a method of operating a provisioning system to manage security preferences for containerized applications.

FIG. 3 illustrates an application container implemented within a host computing system.

FIG. 4 illustrates a host computing system with secure application containers.

FIG. 5 illustrates an overview of the interaction between secure application containers within a computing environment.

FIG. 6 illustrates an application container provisioning system to provision secure application containers.

FIG. 7 illustrates an implementation of a secure application container according to one example.

FIG. 8 illustrates a provisioning computing system to provision secure application containers.

FIG. 9 illustrates a host computing system to provide a platform for secure application containers.

### TECHNICAL DISCLOSURE

Internet services rely extensively on security to prevent unpermitted processes and users from accessing sensitive data. Such data may include usernames, passwords, social security numbers, and credit card numbers, amongst other sensitive data. To prevent improper access, firewalls, antiviruses, and other security processes may be executed on the devices hosting the internet services. These security processes are designed to prevent improper access, or mitigate the effects once a breach has occurred.

In some examples, multiple applications may be necessary to provide specific services to end user devices, such as front-end applications, back-end applications, data service applications, or any other application. Each of these applications are responsible for a particular task, such as taking in and storing data, processing data that is received, organizing data received, or any other task necessary for the service. These applications may be implemented on one or more computing devices configured by an administrator to perform the associated service.

In the present example, application containers are provided to segregate and help secure the data as it is used within the service. These application containers, which operate on a host system, can package an application and its dependencies in a virtual container, and run the containerized application as an isolated process in userspace on the host operating system. These containers may comprise various versions of Linux containers, jails, partitions, or other types of containment modules, and may include virtual machines in some examples. Accordingly, by implementing the container, the application is essentially segregated from other applications and processes executing on the same operating system.

Here, in addition to the application, the container also includes a security layer to act as a barrier or data intermediary between the application and other, local or remote, processes or storage devices. This security layer may include encryption, firewall, storage interface, and communication interface modules that can be configured based on the application for the container. For example, a front-end application that places data within a storage volume may not need access to sensitive data values, such as social security numbers and credit card numbers. Accordingly, rather than letting the application read the received sensitive data, the security layer may encrypt the received data before passing the data to the application.

To generate the application containers for the applications, a provisioning system may be included. This provisioning system may comprise a separate computing system or may reside on a host system capable of providing a platform for executing the application. To initiate the provisioning of the application container, an administrator or some other management service may define an application to be provisioned. Once the application is defined, an application container is provisioned for the application, which contains all of the files, directories, and other similar application elements, and further includes a security layer capable of transparently managing the external interactions with the application, without needing to modify the application itself. For example, the security layer may include one or more modules capable of handling encryption, firewall settings, storage interfaces, and communications with other applications, amongst other possible security layer settings. Accordingly, although the application may be placed on the same host machine as other executing applications, the application may only communicate with external applications, systems, and devices based on the security configuration for the security layer.

In some examples, during the configuration of the application container, the application may be authorized and given a unique and secure identifier such as a digital certificate. The security layer may use this unique identifier, when the application is initiated on a host machine, to gather security settings for the application. For instance, an application container may be provisioned for a front-end application. When the front-end application is deployed within a host computing system, the security layer within the application container may contact a management service to identify the appropriate security settings for the security layer based on the application identifier. In other examples, the security layer may be pre-configured for the application. Accordingly, as an application container is provisioned for a certain application, the security layer may contain the necessary firewall, encryption, storage and communication interface settings for the application.

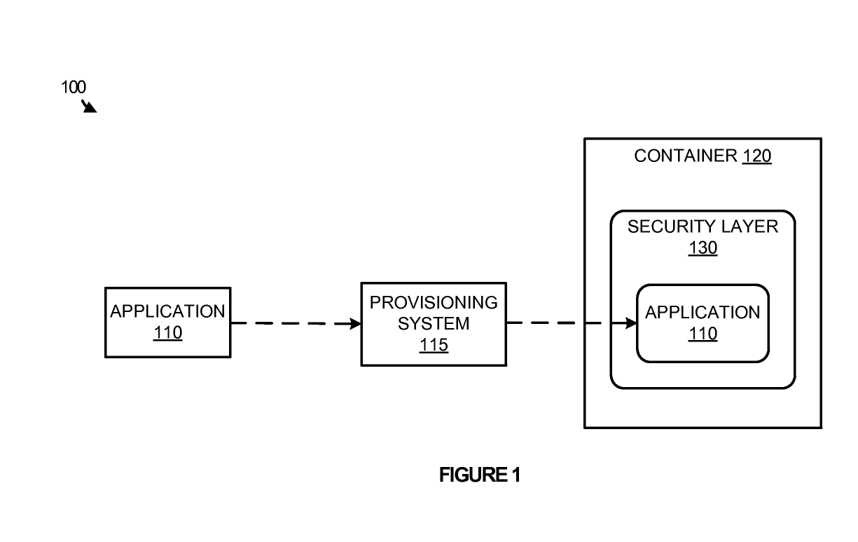

Referring now to FIG. 1, FIG. 1 illustrates a computing environment 100 to provision applications into secure application containers. Computing environment 100 includes application 110, provisioning system 115, and container 120. Container 120 further includes security layer 130 and application 110.

In operation, a developer, an administrator or some other management entity may prefer to generate secure containers for applications, such as application 110. These application containers can package an application and its dependencies as a single container that can run on a variety of operating system versions. Thus, each container effectively segregates the application from other applications and processes executing on the same host operating system and may be deployed independent of the underlying host infrastructure. Once an application is specified, provisioning system 115 may generate or provision container 120 for the application. Container 120 may then be transferred and initiated on a host computing system, such as a server or desktop computer, or may be stored in a storage repository to make the application container available to various end host computing devices.

In addition to provisioning the container with the application, provisioning system 115 may also transparently introduce security layer 130 for application 110. Security layer 130 provides a layer of security between application 110 and other processes or systems executing external to application container 120. Accordingly, by providing each application with a separate security layer, applications may be co-located on the same physical machine, but separated by the security layer between the applications.

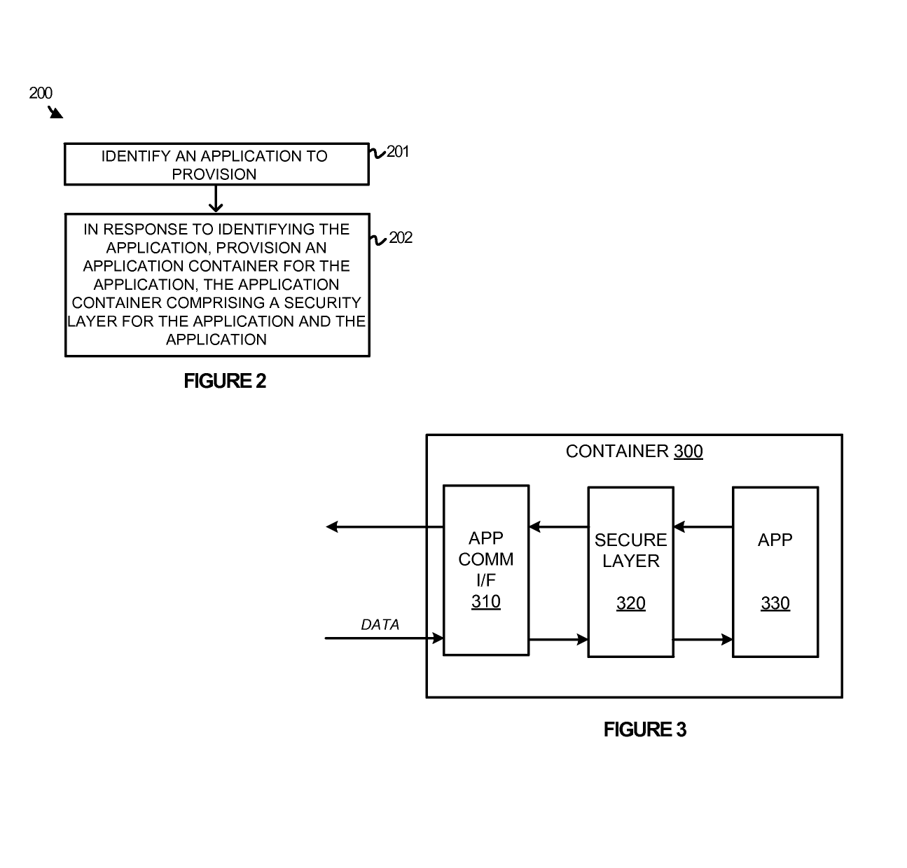

Turning to FIG. 2, FIG. 2 illustrates a method 200 of operating a provisioning system to manage security preferences for containerized applications. As described in FIG. 1, an administrator or some other management process may prefer to generate application containers that separate application dependencies, and make the application easily transferable from one computing system to another. To initiate provisioning of these applications, the provisioning system first identifies an application that requires provisioning (201). This application may comprise front-end server applications, back-end server applications, data processing applications, productivity applications, or any other application.

Once the application is identified by the provisioning system, the provisioning system provisions an application container, wherein the application container includes the application elements, such as files and directories, and further includes a security layer for the application (202). This security layer may include various security modules, such as encryption modules, verification modules, configuration modules, permission modules, or any other similar security type module. Rather than providing an overarching security setting for all applications on a host machine, the security layer may provide individualized settings for each application on the host machine. Thus, although applications may be co-located on the same machine, the applications may not identify any of the other applications or communicate with the other applications based on the settings.

For example, returning to FIG. 1, application 110 may comprise a front-end server application that is used to receive data from one or more computing devices and store the data to a storage repository. Once the application is provisioned in container 120 and implemented within a host environment, security layer 130 may define the necessary security characteristics to prevent improper access to the application, as well as monitor the data that is being stored to the storage repository.

In some examples, during the provisioning of the secure application container, a secure and unique identifier for application 110 may be created, such as a digital certificate. Accordingly, when the application is deployed with container 120, security layer 130 may inquire a management service to determine the appropriate security configuration settings for that application based on the identifier. Once the configuration is received, a management module within the security layer may implement the appropriate settings for the application. By applying a unique identifier for each application container provisioned, the security layer for applications may be applied uniformly, and modified when the application is initiated on a host.

Turning to FIG. 3, FIG. 3 illustrates an application container 300 implemented within a host computing system. Application container 300 includes application communication interface 310, security layer 320, and application 330. Although illustrated separately in the present example, it should be understood that security layer 320 may wholly partially include communication interface 310. Application communication interface 310 allows the application to communicate with other applications and computing devices, and may be configured, in some examples, to communicate with particular processes by security layer 320. Further, in some instances, application communication interface 310 may be configured to communicate with various storage systems, wherein the storage systems may include systems local to the host computing device, as well as storage systems communicatively coupled to the host computing devices. These storage systems may include a variety of devices, including local storage devices, network connected storage devices, or any other similar storage device.

As illustrated, communication interface 310 receives and sends communications to processes and devices external to the application container. Once a communication is received at communication interface 310, the communication is diverted automatically to security layer 320 prior to being passed transparently to application 330. Once the communication arrives at security layer 320, security layer 320 processes the communication based on the security preferences for the application. For example, the security preferences for the application may define that only certain communications from certain sources should be admitted to the application. Accordingly, if a communication is received from an unidentified source, the communication may be stopped before reaching application 330. In contrast, if the communication is from a recognizable source, the communication may be forwarded to application 330. In addition to identifying the source of the communication, security layer 320 may also be used to identify and selectively encrypt all or portions of the data from the external sources, monitor for viruses attempting to infiltrate the application, amongst other security operations prior to the communications reaching application 330.

Similar to the operations for receiving communications, security layer 320 may also be used to monitor the outgoing communications from application 330. For example, content as it leaves application 330 may need to be encrypted before it is communicated or stored in a local or remote storage volume. Accordingly, security layer 320 may intercept at least a portion of the data, encrypt the data, and pass forward the data to the appropriate end destination. Thus, security layer 320 may act as a data intermediary between the application and any other process, device, or system in a computing environment.

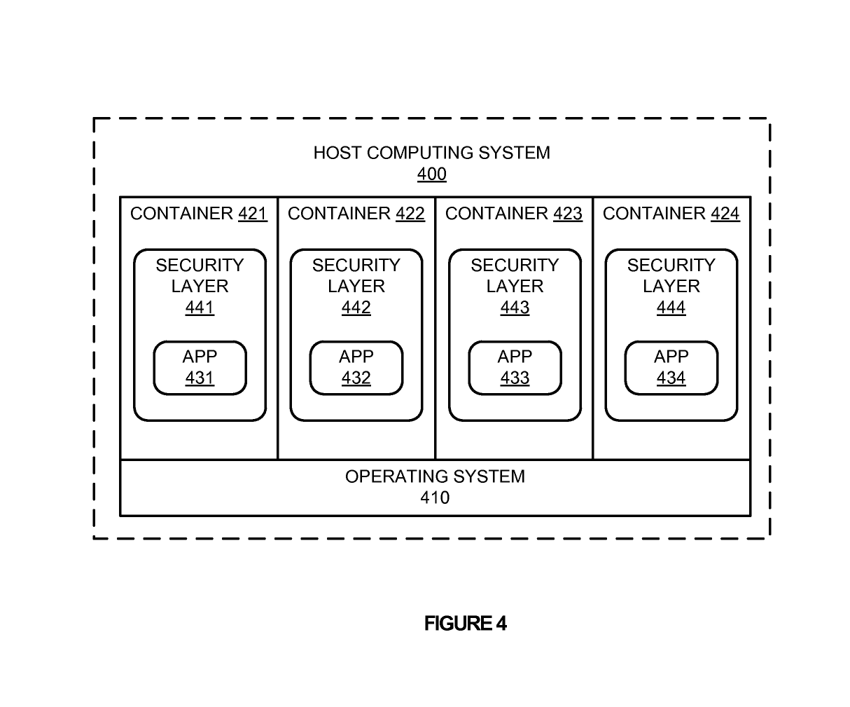

Referring now to FIG. 4, FIG. 4 illustrates a host computing system 400 with secure application containers. Host computing system 400 includes operating system 410 and application containers 421-424. Application containers 421-424 further includes applications 431-434 and security layers 441-444. Host computing system 400 may include server computers, desktop computers, or any other similar computing device capable of executing application containers.

As depicted in FIG. 4, once application containers are generated using a provisioning computing system, the application containers may be implemented within a host computing system. These application containers may include various versions of Linux containers, jails, partitions, or other types of containment modules, and may include virtual machines in some examples. In some instances, the containers allow for a clean separation of infrastructure management and application management, often accomplished by entirely segregated teams within an organization.

In addition to the applications, each container further includes a security layer 441-444, which is used to manage communications coming to and leaving from the application. For example, if an unpermitted application or device transfers a communication to application 431, security layer 441 may be used to stop the communication from reaching application 431. Further, by including a separate security layers for each of the applications, the security layers may be configured individually for each of the applications. This may prevent unpermitted applications, even on the same machine, from communicating with an application.

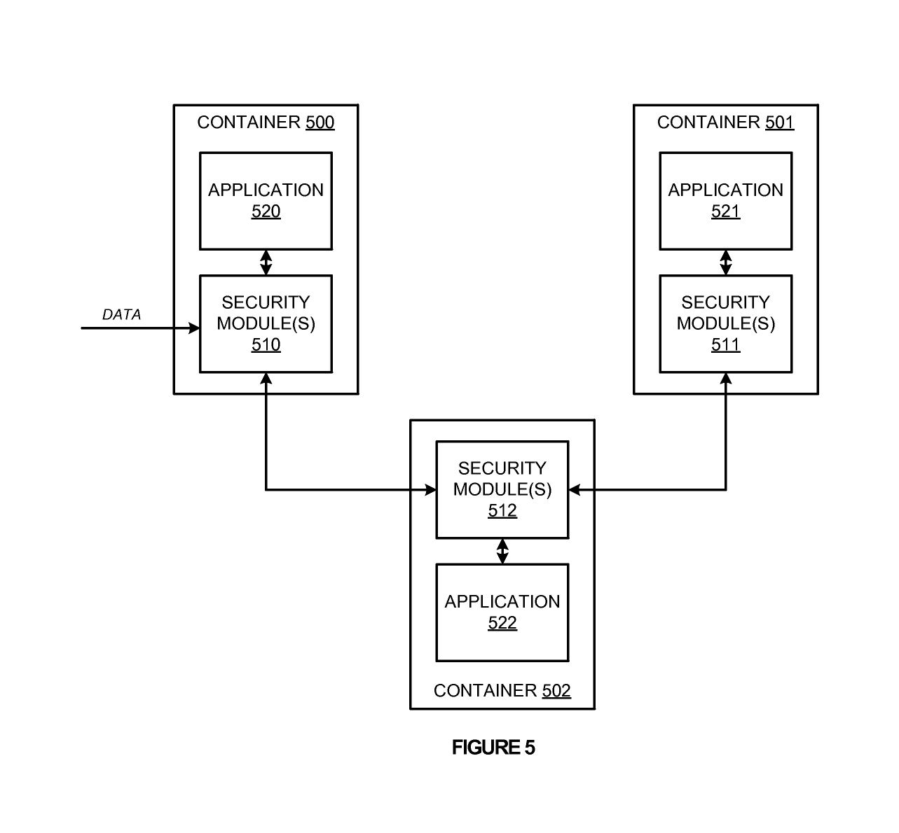

To further illustrate the interaction of containerized applications, FIG. 5 is provided. FIG. 5 illustrates an overview of the interaction between secure application containers within a computing environment. FIG. 5 includes application containers 500-502, which further comprise security modules 510-512 and applications 520-522. Containers 500-502 may reside on one or more host computing devices capable of providing an execution environment for application containers.

As illustrated in FIG. 5, applications 520-522 are incapable of communicating directly with each other. Instead, as data needs to be passed between the various applications, intermediary security modules 510-512, which comprise the security layer for the application, intercept the communications intended for the application. These security modules may include encryption modules, firewall modules, storage interface modules, or a variety of other security modules. In some examples, the security modules may include all of the elements necessary to provide security to the various applications. However, in other instances, the security modules may be configured to borrow security processes built into the host operating system. For example, while an application container is being configured, the security modules within the container may contact the operating system for any necessary security processes required for the application. By implementing the security for each of the applications individually, an administrator or management entity may have more control of the data communicated with a particular application, and may configure security settings for an application that can be distributed across a variety of host platforms.

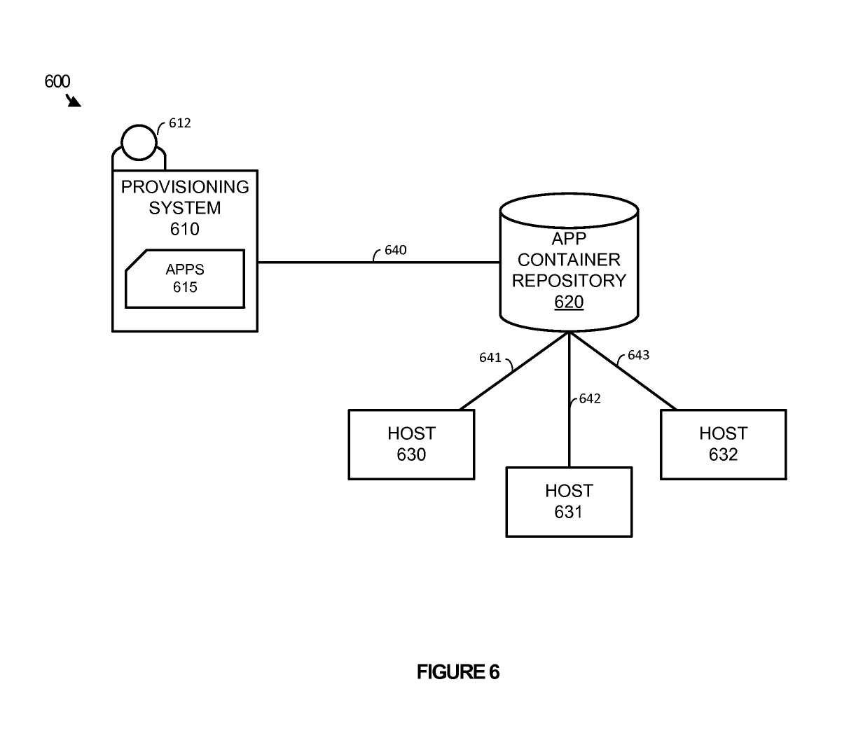

FIG. 6 illustrates an application container provisioning system 600 for provisioning applications in application containers. Application container provisioning system 600 includes provisioning system 610, application container repository 620, and host computing devices 630-632. Provisioning system 610 communicates with container repository 620 over communication link 640. Application container repository 620 communicates with host computing devices 630-632 over communication links 641-643.

In operation, provisioning system 610 is used to provision applications 615 into application containers, wherein each application container includes a security layer and at least one application. For example, an administrator, such as administrator 612, may identify an application to be provisioned into an application container. In response to identifying the application, provisioning system 610 provisions an application container for the application, wherein the application container contains all of the application elements as well as a security layer for the application. This security layer is used as an intermediary between the application and other external processes and systems. Accordingly, when a process or a system attempts to communicate with the application, the security layer may intercept the communication and process the communication using one or more security modules before the communication reaches the application. Similarly, the security layer may be used to intercept outgoing communications from the application. As a result, if the application within the container attempts to transfer a communication to another application or system, the security service may process the communication before passing the communication to the destination. Such processing of the outgoing communications may include encryption, verifying the destination for the communication, or any other similar security settings.

Once the application container is provisioned with the application and the security layer, the application container may be stored within application container repository 620. Application container repository 620 may comprise one or more storage mediums capable of storing a variety of application containers, and may comprise a serving computing system in some examples. Upon storing the application containers within container repository 620, host computing devices 630-632 may access the applications and implement the applications locally. This implementation may include downloading the appropriate application container from storage repository 620 and initializing the application container within the host computing system. For example, provisioning system 610 may be used to provision a front-end server application that is then stored in application container repository 620. Once the application is stored in application container repository 620, host computing systems 630-632 may contact container repository 620 to retrieve the application container.

Although illustrated with an application container repository in the present example, it should be understood that applications might be provisioned directly into a host computing system. Accordingly, when an administrator identifies a desired application, the application may be placed in a container with a security layer, and made available on the host computing system.

Returning to the elements of FIG. 6, provisioning system 610, application container repository 620, and host computing devices 630-632 may each comprise a router, server, memory device, software, processing circuitry, cabling, power supply, network communication interface, structural support, or some other communication or computer apparatus. In particular, provisioning system 610, may include software capable of provisioning applications into application containers with a security layer, container repository may comprise any device or collection of devices capable of storing the application containers, and host computing devices 630-632 may comprise any computing device or devices capable of executing the provisioned applications in the containers.

Communication links 640-643 each use metal, glass, optical, air, space, or some other material as the transport media. Communication links 640-643 may use Time Division Multiplex (TDM), asynchronous transfer mode (ATM), IP, Ethernet, synchronous optical networking (SONET), hybrid fiber-coax (HFC), circuit-switched, communication signaling, wireless communications, or some other communication format, including improvements thereof. Communication links 640-643 may each be a direct link, or can include intermediate networks, systems, or devices, and can include a logical network link transported over multiple physical links.

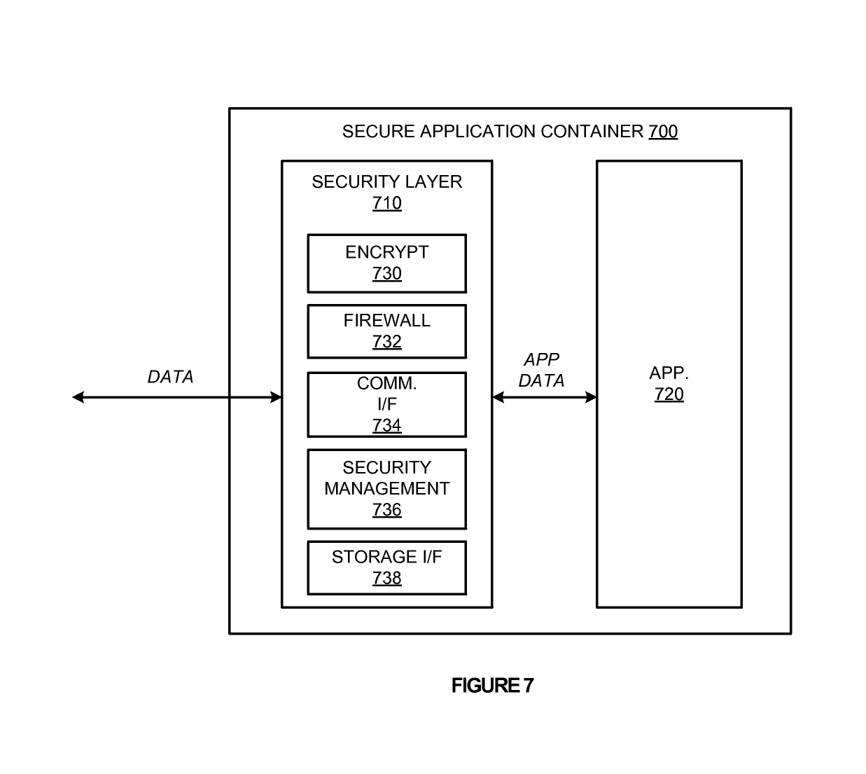

FIG. 7 illustrates an implementation of a secure application container 700 according to one example. Secure application container 700 includes security layer 710 and application 720. Security layer 710 further includes encryption module 730, firewall module 732, communication interface module 734, security management module 736, and storage interface module 738. In operation, an administrator or some other management object may identify an application to be provisioned into an application container. An application container comprises the application and its dependencies, and runs as an isolated process in userspace on the host operating system. Each application container may comprise a versions of a Linux containers, jail, partition, or other type of containment module, and may include a virtual machine in some examples.

As illustrated in FIG. 7, in addition to the application itself, secure application container 700 includes security layer 710 and the corresponding modules. Each security module is configured to perform a set of tasks including encryption, firewall management, processing communications from external processes or processing storage calls to local or remote storage volumes. For example, as secure application container 700 receives data communications, the communication is first directed to security layer 710. Once the security modules process the communication, the processed communication, illustrated in FIG. 7 as application data, is transferred to the application. In some examples, the processed data may include an encrypted version of some or all of data received at the security layer. Accordingly, although received by the container as unencrypted data, the application may only receive an encrypted version of the data from security layer 710.

Similar to the incoming communications, security layer 710 may also be used to handle outgoing communications from application 720. Thus, security layer 710 may manage the devices, systems, and processes that application 720 contacts, the encryption of data leaving application 720, or any other similar security parameter for communications from the containerized application. The security layer could similarly intercept and process all local and remote reads, writes, and updates to storage volumes from application 720.

In some examples, each secure application container may be given a unique and secure identifier such as a digital certificate that can be used to configure the security layer for a particular application. For instance, if secure application container 700 were deployed in a host environment, the container may contact a management service to identify security preferences or settings for the application. In response to the request, the management system may verify the identifier of the application container, and transfer security preferences to be implemented for the particular application.

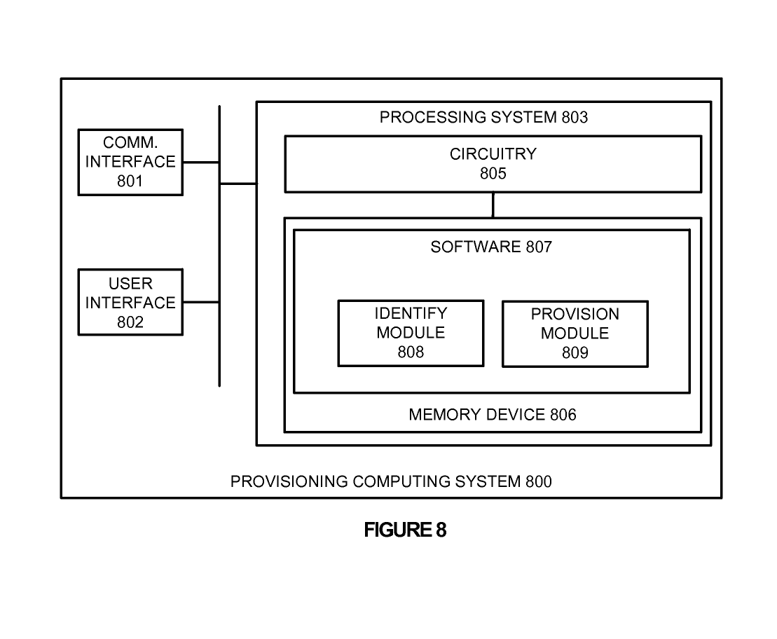

FIG. 8 illustrates a provisioning computing system 800 to provision secure application containers according to one example. Provisioning computing system 800 is representative of a computing system that may be employed in any computing apparatus, system, or device, or collections thereof, to suitably implement the provisioning systems described herein to provision secure application containers. Computing system 800 comprises communication interface 801, user interface 802, and processing system 803. Processing system 803 is linked to communication interface 801 and user interface 802. Processing system 803 includes processing circuitry 805 and memory device 806 that stores operating software 807.

Communication interface 801 comprises components that communicate over communication links, such as network cards, ports, RF transceivers, processing circuitry and software, or some other communication devices. Communication interface 801 may be configured to communicate over metallic, wireless, or optical links. Communication interface 801 may be configured to use TDM, IP, Ethernet, optical networking, wireless protocols, communication signaling, or some other communication format—including combinations thereof. Communication interface 801 may be configured in some examples to communicate with one or more host machines, and may also communicate with a storage repository to store application containers for the host machines.

User interface 802 comprises components that interact with a user. User interface 802 may include a keyboard, display screen, mouse, touch pad, or some other user input/output apparatus. User interface 802 may, in some examples, be used to receive user input indicating an application to be provisioned and a destination for the provisioned application container. User interface 802 may be omitted in some examples.

Processing circuitry 805 comprises microprocessor and other circuitry that retrieves and executes operating software 807 from memory device 806. Memory device 806 comprises a non-transitory storage medium, such as a disk drive, flash drive, data storage circuitry, or some other memory apparatus. Operating software 807 comprises computer programs, firmware, or some other form of machine-readable processing instructions. Operating software 807 includes identify module 808 and provision module 809, although any number of modules might provide the same operation. Operating software 807 may further include an operating system, utilities, drivers, network interfaces, applications, or some other type of software. When executed by circuitry 805, operating software 807 directs processing system 803 to operate provisioning computing system 800 as described herein.

In particular, identify module 808 is configured to identify one or more applications to be provisioned into application containers. Once the applications are identified, provisioning module 809 provisions an application container for the application, wherein the application container includes the application and a security layer for the application. In some examples, the security layer that is provided for the application includes one or more security modules that are used to act as an intermediary between the application within the container, and processes, devices, and storage systems that are external to the container. For instance, an application within the container may be configured to receive social security numbers, or other similar user sensitive information from an external application. If the application within the container does not require the actual social security numbers, a security module within the security layer may intercept the communication intended for the containerized application, encrypt the sensitive data, and provide the encrypted version of the social security number to the application. Accordingly, although the application may never recognize the modification in numbers, the data may be encrypted to prevent improper access at the application level. This technique could also be used to grant partial access to the data based on the identified need of the application. For example, if the application within the container requires only the last four digits of the social security numbers, the security module may obfuscate the first five digits of the social security number and expose the resulting social security number to the application.

In some examples, once the application container is provisioned, the application container may be implemented on the same computing device. However, in other instances, the application may be transferred to other host computing systems or to a storage repository that can be used to distribute the applications to various computing devices.

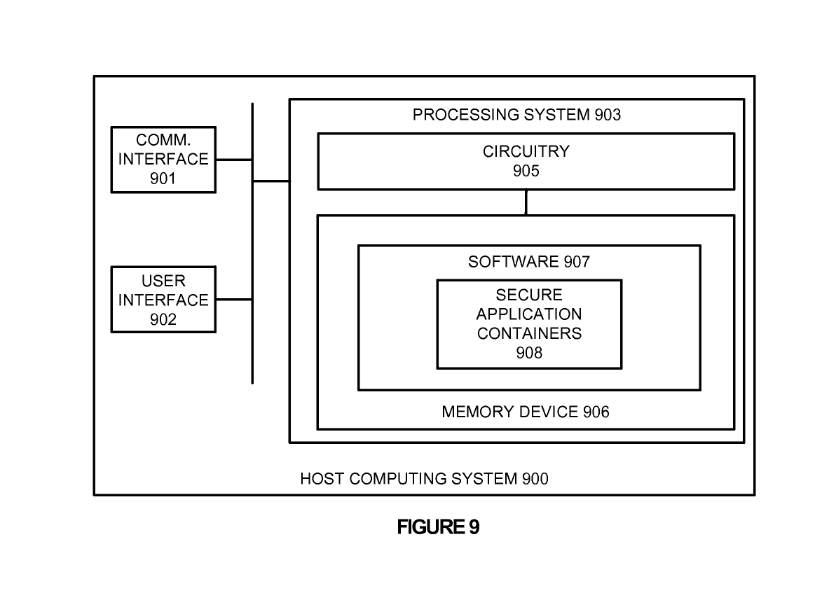

FIG. 9 illustrates a host computing system 900 to provide a platform for secure application containers. Host computing system 900 is representative of a computing system that may be employed in any computing apparatus, system, or device, or collections thereof, to suitably implement the host computing systems described herein capable of providing a platform for secure application containers. Computing system 900 comprises communication interface 901, user interface 902, and processing system 903. Processing system 903 is linked to communication interface 901 and user interface 902. Processing system 903 includes processing circuitry 905 and memory device 906 that stores operating software 907.

Communication interface 901 comprises components that communicate over communication links, such as network cards, ports, RF transceivers, processing circuitry and software, or some other communication devices. Communication interface 901 may be configured to communicate over metallic, wireless, or optical links. Communication interface 901 may be configured to use TDM, IP, Ethernet, optical networking, wireless protocols, communication signaling, or some other communication format—including combinations thereof.

User interface 902 comprises components that interact with a user. User interface 902 may include a keyboard, display screen, mouse, touch pad, or some other user input/output apparatus. User interface 902 may be omitted in some examples.

Processing circuitry 905 comprises microprocessor and other circuitry that retrieves and executes operating software 907 from memory device 906. Memory device 906 comprises a non-transitory storage medium, such as a disk drive, flash drive, data storage circuitry, or some other memory apparatus. Operating software 907 comprises computer programs, firmware, or some other form of machine-readable processing instructions. Operating software 907 includes secure application containers 908. Operating software 907 may further include an operating system, utilities, drivers, network interfaces, applications, or some other type of software. When executed by circuitry 905, operating software 907 directs processing system 903 to operate host computing system 900 as described herein.

In particular, host computing system 900 comprises software and other processing elements capable of providing a platform for secure application containers 908. Application containers 908 include an application specified by an administrator or some other management process, and further include a security layer that acts as an intermediary between the containerized application and processes and systems external to the application container. These processes and systems may include other applications, computing devices, storage systems, or the like. In some examples, the application containers rely on the operating system kernel functionality to provide resource isolation for the host computing elements, such as the processing unit, memory, block input/output, network, and other similar elements. Accordingly, the security layer and the application may execute without acknowledging other processes on the same host computing system.

The included descriptions and figures depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method of operating a provisioning system to provision secure application containers, the method comprising:
identifying an application to provision;
in response to identifying the application, provisioning a secure application container for the application, the secure application container comprising a security layer for the application and the application.

2. The method of claim 1 wherein the security layer for the application comprises an intermediary security layer configured to act as a data intermediary between the application and at least one process, device, or storage system external to the secure application container.

3. The method of claim 1 further comprising:
identifying a second application to provision;
in response to identifying the second application, provisioning a second secure application container for the second application, the second secure application container comprising a second security layer for the second application and the second application.

4. The method of claim 1 further comprising:
transferring the secure application container to a host computing device.

5. The method of claim 1 further comprising:
storing the secure application container in a storage repository, the storage repository accessible by one or more host computing devices.

6. The method of claim 1 wherein the application comprises a front-end application.

7. The method of claim 1 wherein the application comprises a back-end application.

8. The method of claim 1 wherein the security layer comprises one or more security modules configured for the application.

9. The method of claim 8 wherein the one or more security modules comprise at least encryption, firewall, and storage interface modules for the application.

10. A computer apparatus to provision secure application containers, the computer apparatus comprising:
processing instructions that direct a provisioning computing system, when executed by the provisioning computing system, to:
identify an application to provision; and
in response to identifying the application, provision the secure application container for the application, the secure application container comprising a security layer for the application and the application; and
one or more non-transitory computer readable media that store the processing instructions.

11. The computer apparatus of claim 10 wherein the security layer for the application comprises an intermediary security layer configured to act as a data intermediary between the application and at least one process, device, or storage system external to the secure application container.

12. The computer apparatus of claim 10 wherein the processing instructions further direct the provisioning computing system to:
identify a second application to provision; and
in response to identifying the second application, provision a second secure application container for the second application, the second secure application container comprising a second security layer for the second application and the second application.

13. The computer apparatus of claim 10 wherein the processing instructions further direct the provisioning computing system to transfer the secure application container to a host computing device.

14. The computer apparatus of claim 10 wherein the processing instructions further direct the provisioning computing system to store the secure application container in a storage repository, the storage repository accessible by one or more host computing devices.

15. The computer apparatus of claim 10 wherein the application comprises a front-end application.

16. The computer apparatus of claim 10 wherein the application comprises a back-end application.

17. The computer apparatus of claim 10 wherein the security layer comprises one or more security modules configured for the application.

18. The computer apparatus of claim 10 wherein the one or more security modules comprise at least encryption, firewall, and storage interface modules for the application.
